(19) United States
(12) Patent Application Publication
(10) Pub. No.: US 2015/0026549 A1
(43) Pub. Date: Jan. 22, 2015

(54) METHOD AND SYSTEM FOR COPYING AND PASTING WEBPAGE CONTENT, AND COMPUTER STORAGE MEDIUM

(71) Applicant: TENCENT TECHNOLOGY (SHENZHEN) COMPANY LIMITED, Shenzhen City, Guangdong (CN)

(72) Inventor: Heming Shao, Shenzhen City (CN)

(73) Assignee: TENCENT TECHNOLOGY (SHENZHEN) COMPANY LIMITED, Shenzhen City, Guangdong (CN)

(21) Appl. No.: 14/382,736

(22) PCT Filed: Jun. 27, 2013
(86) PCT No.: PCT/CN2013/078234

§ 371 Date: Sep. 3, 2014

(30) Foreign Application Priority Data
Jun. 29, 2012 (CN) 201210222888.4

(51) Int. Cl. G06F 3/0484; G06F 17/22; G06F 3/0481

(52) U.S. Cl. CPC G06F 3/0484; G06F 3/04817; G06F 17/2235; G06F 17/2247
USPC 715/205; 715/234

(57) ABSTRACT

A method for copying and pasting webpage content comprises the following steps: acquiring a copy instruction of copying webpage content; appending the webpage content into a clipboard, wherein the clipboard is a designated file under a preset directory; acquiring a paste instruction of pasting the webpage content in the clipboard to a target position; and pasting the webpage content corresponding to the paste instruction to the target position. In the method for copying and pasting webpage content, a clipboard is a designated file under a preset directory, webpage content copied in multiple times can be added to the clipboard, and the webpage content in the clipboard can be pasted to a target position, so that different webpage content copied in multiple times can be pasted for multiple times, which facilitates operation of a user. Also provided are a system for copying and pasting webpage content and a computer storage medium.

### CROSS-REFERENCE TO RELATED APPLICATIONS

The application claims the benefit of Chinese application No. 201210222888.4 filed Jun. 29, 2012, entitled “METHOD AND SYSTEM FOR COPYING AND PASTING WEBPAGE CONTENT, AND COMPUTER STORAGE MEDIUM”, the entire content of which is incorporated herein by reference in its entirety.

### FIELD OF THE INVENTION

The present invention relates generally to network technologies, and more particularly relates to a method and a system for copying and pasting webpage content, and a computer storage medium.

### BACKGROUND OF THE INVENTION

The clipboard is a continuous memory space of an operating system for the temporary storage of exchange information, the size thereof can change with the size of the stored information. The clipboard is built inside of the operating system, and is used for the temporary storage of the cut and copy information via internal resource RAM or virtual memory of the system.

As a bridge, the small clipboard makes the information be transferred and shared between various applications. However, the drawback is that the clipboard can only keep a piece of data, when new data is incoming, the old data will be overwritten. Therefore, the pasted content will always be the final copied content; the multiple copied contents cannot be pasted.

When a user copies and pastes webpage content, a conventional browser does not respond to the copy and paste instructions; while the copy and paste program of the operating system makes the response to the instructions. Therefore, when the webpage content is copied and pasted, only the final copy webpage content is pasted, the multiple copied webpage contents cannot be pasted.

### SUMMARY OF THE INVENTION

Accordingly, it is necessary to provide a method for copying and pasting webpage content which is able to paste the multiple copied contents.

In one aspect of the invention, the method for copying and pasting webpage content includes: acquiring a copy instruction of copying webpage content; appending the webpage content to a clipboard, wherein the clipboard is a designated file under a preset directory; acquiring a paste instruction of pasting the webpage content in the clipboard to a target position; and pasting the webpage content corresponding to the paste instruction to the target position.

Accordingly, it is necessary to provide a system which is able to paste the multiple copied contents.

In another aspect of the invention, the system for copying and pasting webpage content includes: an instruction acquiring module configured to acquire a copy instruction of copying a webpage content; a copy module configured to append the webpage content to a clipboard, wherein clipboard is a designated file under a preset directory; the instruction acquiring module is also configured to acquire a paste instruction of pasting the webpage content in the clipboard to a target position; and a paste module configured to paste the webpage content corresponding to the paste instruction to the target position.

In addition, it is necessary to provide a computer storage medium which is able to paste the multiple copied contents.

In yet another aspect of the invention, the computer storage medium comprising computer-executable instructions, wherein the computer-executable instruction are configured such that when executed by one or more processors, the computer-executable instructions cause a system to perform a method for copying and pasting webpage content, the method includes: acquiring a copy instruction of copying webpage content; appending the webpage content to a clipboard, wherein the clipboard is a designated file under a preset directory; acquiring a paste instruction of pasting the webpage content in the clipboard to a target position; and pasting the webpage content corresponding to the paste instruction to the target position.

In the invented method, system, and computer storage medium for copying and pasting webpage content, the clipboard is a designated file under a preset directory, which is able to append the multiple copied webpage contents to the clipboard, and the object in the clipboard can be pasted to the position where it is needed. Accordingly, the different multiple copied webpage contents can be pasted for multiple times, the operating convenience for the user is improved.

### BRIEF DESCRIPTION OF THE DRAWINGS

FIG. 1 is a flow diagram of a method for copying and pasting webpage content according to one embodiment of the invention;

FIG. 2 is an interface schematic of a prompt icon and a clipboard window according to one embodiment of the invention;

FIG. 3 is a block diagram of a system for copying and pasting webpage content according to one embodiment of the invention; and

FIG. 4 is block diagram of a system for copying and pasting webpage content according to another embodiment of the invention.

### DETAILED DESCRIPTION OF THE EMBODIMENTS

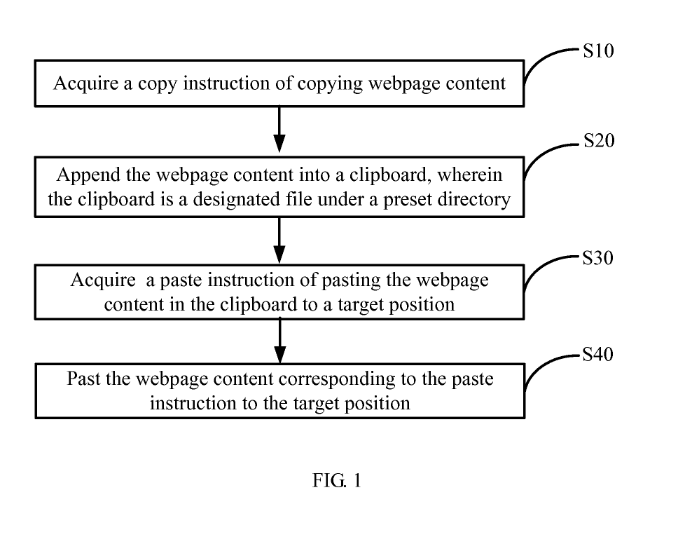

Referring to FIG. 1, a method for copying and pasting webpage content according to an embodiment includes the following steps:

At step S10, a copy instruction of copying webpage content is acquired.

Specifically, the copied webpage content (the webpage content corresponding to the copy instruction) of the copy instruction is the selected webpage content. Furthermore, the webpage content may include text, picture, text link, picture link and so on. The text link is a link using the text as a linked object. The picture link is a link using the picture as a linked object. A target object pointed by the link can be webpage, picture, video, file or other applications.

At step S20, the webpage content is appended to a clipboard, which is a designated file under a preset directory.

Specifically, the clipboard is a designated file stored in a local preset directory of a browser. Prior to the step S20, whether the designated file under a local preset directory exists will be checked. If the designated file does not exist, the designated file is then created under the preset directory.

Furthermore, the selected webpage content in the webpage is appended to an end of the clipboard file, i.e. the webpage content is appended to the end of the file in the designated file under the preset directory.

At step S30, a paste instruction of pasting the webpage content in the clipboard to a target position is acquired.

In one embodiment, the target position may be a position where the cursor in the data editing area of the user interface locates. If the paste instruction is triggered by dragging the webpage content, then the target position is the final position of the drag operation.

At step S40, the webpage content corresponding to the paste instruction to the target position is pasted.

Specifically, the webpage content corresponding to the paste instruction is inserted at the position where the cursor in the data editing area of the user interface locates, or the webpage content corresponding to the paste instruction is inserted at the final position of the drag operation trigging the paste instruction.

In one embodiment, after the step S20, a clipboard window is displayed, the clipboard window displays the entry corresponding to the webpage content contained in the clipboard. When the clipboard contains multiple webpage contents, the clipboard window will display the webpage contents divided in entry.

Specifically, in the step S30, the paste instruction can be acquired by the clipboard window. When an instruction of pasting at least one entry selected from the clipboard window to the target position is acquired, the webpage content corresponding to the selected entry can be found in the clipboard.

Furthermore, in the step S40, the webpage content corresponding to the selected entry is pasted to the target position.

In the described method for copying and pasting webpage content, the clipboard is the designated file under a preset directory, the multiple copied webpage contents can be appended to the clipboard, and the webpage content in the clipboard can be pasted to the position where it is needed. Accordingly, the different multiple copied webpage contents can be pasted for multiple times, the operating convenience for the user is improved.

In one embodiment, the specific process of the step S20 includes: if the webpage content contains a link, the URL information of a target object pointed by the contained link is appended to the clipboard.

Specifically, the link includes a text link or a picture link, i.e. the object configured to be a hyperlink can be a text or a picture. The URL is Uniform Resource Locator. The URL information of the target object pointed by the link can be an address of the webpage, a download address of a file and so on.

Specifically, the URL information of the target object pointed by the link can be found in the source file of the webpage; then the URL information of the target object pointed by the link is appended to the end of the clipboard file.

In one embodiment, the specific process of the step S40 includes: if the webpage content corresponding to the paste instruction contains a link, the URL information of the target object pointed by the contained link in the webpage content corresponding to the paste instruction is pasted to the target potion.

For example, if the webpage content corresponding to the copy instruction contains a text link which points to another webpage; then in the step S20, the URL information of the webpage pointed by the text link is acquired in the source file of the current webpage; and then the URL information of the webpage pointed by the text link is appended to the clipboard. In the step S40, when the described webpage content corresponding to the copy instruction is pasted, the URL information of the webpage pointed by the text link can be pasted to the target position.

For another example, if the webpage content corresponding to the copy instruction contains a picture link which points to a video; then in the step S20, the URL information (may be a download address) of the video pointed by the picture link can be acquired from the source file of the current webpage; then the URL information of the video pointed by the picture link is appended to the clipboard. In the step S40, when the webpage content corresponding to the described copy instruction is pasted, the URL information of the video pointed by the picture link is pasted to the target position. In the illustrated embodiment, the URL information of the target object pointed by the link can be automatically appended to the clipboard. Moreover, when the webpage content is pasted in the clipboard, the URL information of the target object pointed by the link contained in the webpage content is pasted to the target position. No additional operation is needed to copy and paste the URL information of the target object pointed by the link, thus the operation for the user is simplified.

In one embodiment, the described method for coping and pasting webpage content further includes: displaying a prompt icon for prompting there is content in the clipboard when the clipboard is not empty; displaying a clipboard window when an instruction of clicking the prompt icon is acquired. The clipboard window displays the webpage content contained in the clipboard.

Specifically, the clipboard window can display the contained webpage content in the clipboard divided in entry.

In one embodiment, the clipboard window can display the prompt icon corresponding to the webpage content or the text contained in the webpage content and so on. For example, when the copied webpage content is picture, the clipboard window can display the thumbnail of the picture.

In the illustrated embodiment, the clipboard window is displayed after the instruction of clicking the prompt icon is acquired. When only the prompt icon is displayed, much less space of the interface is occupied, which is convenient for the user.

In one embodiment, if the webpage content corresponding to the copy instruction contains a link, then in the step S20, the linked object of the link and the URL information of the target object pointed by the link are appended to the clipboard. For example, the linked object of the picture link is a piece of picture, if the target object pointed by the picture link is a webpage, then the picture and the URL information of the webpage are appended to the clipboard.

When the webpage content corresponding to the copy instruction is displayed in the clipboard window, the linked object of the link contained in the webpage content and the URL information of the target object pointed by the link can be combined into a link, and the combined link is displayed in the clipboard window. When the instruction of clicking the link in the clipboard window is acquired, the target object pointed by the link is opened.

For example, if the webpage content contains a text link pointing to a certain webpage, then the text used as the linked object of the text link and the URL information of the webpage pointed by the text link are acquired in the clipboard, then the acquired text and the URL information of the webpage are combined into a link which is displayed in the clipboard window. When the instruction of clicking the link is acquired, the webpage pointed by the link is opened. If the link displayed in the clipboard points to a video, then when the instruction of clicking the link is acquired, the video is acquired and played according to the URL information of the video pointed by the link.

In the illustrated embodiment, the target object pointed by the link can be found by directly clicking the link in the clipboard window, there is no need to click the link and find the target object pointed by the link after pasting the link in the clipboard window to the target position. Thus the operation is convenient for the user.

In one embodiment, if the instruction of clicking the prompt icon is acquired after the clipboard window is displayed, the clipboard window is hided.

In the illustrated embodiment, the clipboard window is hided when no webpage content is needed to be pasted, thus the coverage of the interface is reduced, and the operation is convenient for the user.

In the illustrated embodiment, the prompt icon is hided when the clipboard is empty, thus the coverage of the interface can be reduced, and the operation is convenient for the user.

In one embodiment, the prompt icon and the clipboard window are cross-page global objects. All webpage opened by the browser share one prompt icon and one clipboard window.

In the illustrated embodiment, the different webpage contents of different webpage are pasted to the clipboard, and the webpage contents in the clipboard are pasted to the target positions of different webpage. The convenience of the copy-paste operation is improved.

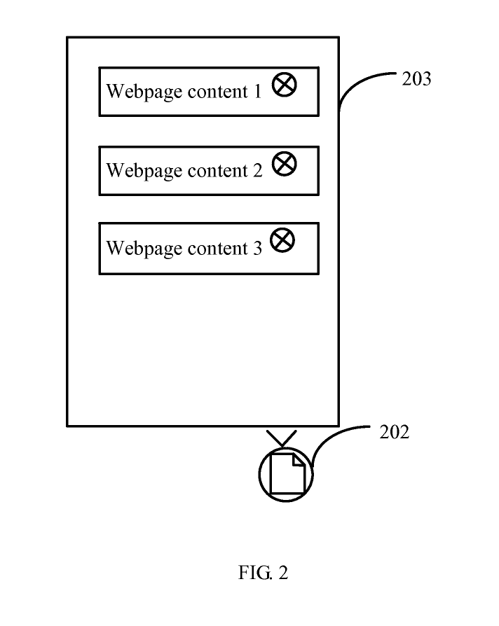

Referring to FIG. 2, in an embodiment, when there is an object in the clipboard, the prompt icon 202 will be displayed. When the instruction of clicking the prompt icon 202 is acquired, the clipboard window 203 is displayed. Specifically, the webpage contents in the clipboard can be displayed in the clipboard window 203 divided in entry. When there is no webpage content in the clipboard, the prompt icon 202 and the clipboard window 203 will be hided.

In one embodiment, after the step S40, the webpage content corresponding to the copy instruction is deleted from the clipboard. Furthermore, in an embodiment, if the clipboard window is in a displaying status, then the webpage content corresponding to the copy instruction is deleted from the clipboard.

In the illustrated embodiment, the deletion of the pasted webpage content from the clipboard and the clipboard window can reduce the entry displayed in the clipboard, simply the display of the clipboard window, and is convenient for the user to select the webpage content from the clipboard window and paste the webpage content.

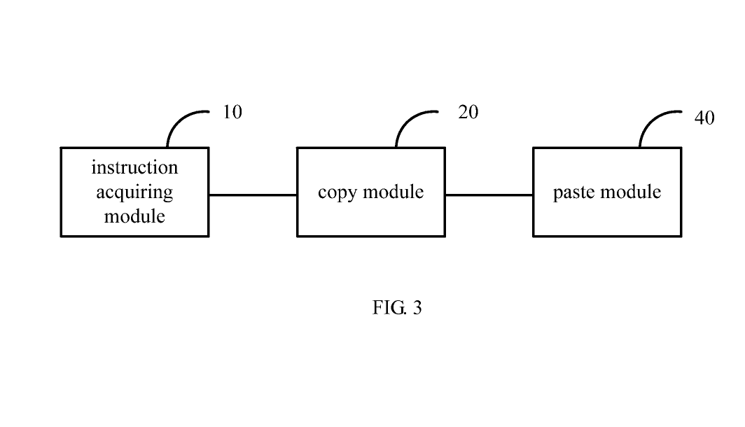

Referring to FIG. 3, in an embodiment, a system for copying and pasting webpage content includes an instruction acquiring module 10, a copy module 20, and a paste module 40.

The instruction acquiring module 10 is configured to acquire a copy instruction of copying webpage content.

Specifically, the copied webpage content of the copy instruction (the webpage content corresponds to the copy instruction) is the selected webpage content. Furthermore, the webpage content may include text, picture, text link, picture link and so on. The text link is a link using the text as a linked object. The picture link is a link using the picture as a linked object. A target object pointed by the link can be webpage, picture, video, file or other applications.

The copy module 20 is configured to append the webpage content to a clipboard which is a designated file under a preset directory.

Specifically, the clipboard is a designated file stored in a local preset directory of a browser. In one embodiment, the copy module 20 is configured to check whether the designated file under a local preset directory exists. If the designated file does not exist, then the designated file is created under the preset directory. Furthermore, the copy module 20 is configured to append the selected webpage content in the webpage to an end of the designated file under the preset directory, i.e. the webpage content is appended to the end of the file in the default directory under the preset directory.

The instruction acquiring module 10 is configured to acquire a paste instruction of pasting the webpage content in the clipboard to a target position.

In one embodiment, the target position may be a position where the cursor in the data editing area of the user interface locates. If the paste instruction is triggered by dragging webpage content, then the target position is the final position of the drag operation.

The paste module 40 is configured to paste the webpage content corresponding to the paste instruction to the target position.

Specifically, the paste module 40 is configured to insert the webpage content corresponding to the paste instruction to the position where may be a position where the cursor in the data editing area of the user interface locates; or insert the webpage content corresponding to the paste instruction to the final position of the drag operation trigging the paste instruction.

Specifically, the instruction acquiring module 10 is configured to acquire the paste instruction via the clipboard window. The clipboard window displays the entry corresponding to the webpage content contained in the clipboard. When the clipboard contains multiple webpage contents, the clipboard window will display the webpage contents divided in entry.

When the instruction acquiring module 10 acquires the instruction of pasting the entry selected from the clipboard window to the target position, the paste module 40 finds the webpage content corresponding to the selected entry in the clipboard. Furthermore, the paste module 40 pastes the webpage content corresponding to the selected entry to the target position.

In the described system for copying and paste webpage content, the clipboard is the designated file under a preset directory; which is able to paste the multiple copied webpage contents to the clipboard, and the webpage content in the clipboard can be pasted to the position where it is needed. Accordingly, the different multiple copied webpage contents can be pasted for multiple times, the operating convenience for the user is improved.

In one embodiment, the copy module 20 is configured to: if the webpage content contains a link, append the URL information of a target object pointed by the contained link to the clipboard.

Specifically, the link includes text link, picture link and so on. The URL is Uniform Resource Locator. The URL information of the target object pointed by the link can be an address of the webpage, a download address of a file and so on.

Specifically, the copy module 20 is configured to find the URL information of the target object pointed by the link in the source file of the webpage; and append the URL information of the target object pointed by the link to the end of the clipboard file.

In one embodiment, the paste module 40 is configured to: if the webpage content corresponding to the paste instruction contains a link, paste the URL information of the target object pointed by the contained link in the webpage content corresponding to the paste instruction to the target potion.

For example, if the webpage content corresponding to the copy instruction contains a text link which points to another webpage; the copy module 20 acquires the URL information of the webpage pointed by the text link from the source file of the current webpage, then the copy module 20 appends the URL information of the webpage pointed by the text link to the clipboard. When the paste module 40 pastes the described webpage content corresponding to the copy instruction, the paste module pastes the URL information of the webpage pointed by the text link to the target position.

For another example, if the webpage content corresponding to the copy instruction contains a picture link which points to a video; then in the step S20, the URL information (may be a download address) of the video pointed by the picture link can be acquired from the source file of the current webpage, then the URL information of the video pointed by the picture link is appended to the clipboard. In the step S40, when the webpage content corresponding to the described copy instruction is pasted, the URL information of the video pointed by the picture link is pasted to the target position.

In the illustrated embodiment, the URL information of the target object pointed by the link can be automatically appended to the clipboard. Moreover, when the webpage content is pasted in the clipboard, the URL information of the target object pointed by the link contained in the webpage content is pasted to the target position. No additional operation is needed to copy and paste the URL information of the target object pointed by the link, thus the operation for the user is simplified.

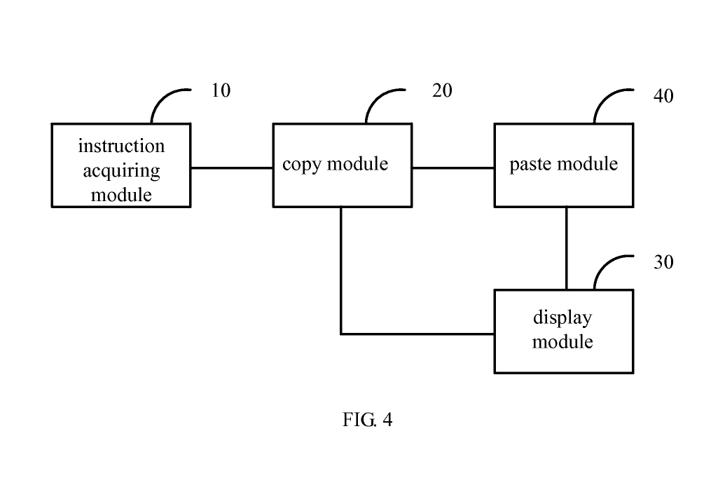

Referring to FIG. 4, in an embodiment, the described system for coping and pasting webpage content further includes a display module 30, which is configured to: display a prompt icon for prompting there is content in the clipboard when the clipboard is not empty; display a clipboard window when an instruction of clicking the prompt icon is acquired. The clipboard window displays the webpage content contained in the clipboard.

Specifically, the clipboard window can display the contained webpage content in the clipboard divided in entry.

In one embodiment, the display module 30 can display the prompt icon corresponding to the webpage content or the text contained in the webpage content and so on. For example, when the copied webpage content is picture, the clipboard window can display the thumbnail of the picture.

In the illustrated embodiment, the clipboard window is displayed after the instruction of clicking the prompt icon is acquired. When only the prompt icon is displayed, much less space of the interface is occupied, which is convenient for the user.

In one embodiment, if the webpage content corresponding to the copy instruction contains a link, the copy module 20 can append the linked object of the link and the URL information of the target object pointed by the link to the clipboard. For example, the linked object of the picture link is a piece of picture, if the target object pointed by the picture link is a webpage, then the picture and the URL information of the webpage are appended to the clipboard.

When the display module 30 displays the webpage content corresponding to the copy instruction in the clipboard window, the linked object of the link contained in the webpage content and the URL information of the target object pointed by the link can be combined into a link; and the combined link is displayed in the clipboard window. When the instruction of clicking the link in the clipboard window is acquired, the target object pointed by the link is opened.

For example, if the webpage content contains a text link pointing to a certain webpage, then the display module 30 can acquire the text used as the linked object of the link and the URL information of the webpage pointed by the text link in the clipboard, and the acquired text and the URL information of the webpage are combined into a link which is displayed in the clipboard window. When the instruction of clicking the link is acquired, the webpage pointed by the link is opened. If the link displayed in the clipboard points to a video, then when the instruction of clicking the link is acquired, the video is acquired and played according to the URL information of the video pointed by the link.

In the illustrated embodiment, the target object pointed by the link can be found by directly clicking the link in the clipboard window, there is no need to click the link and find the target object pointed by the link after pasting the link in the clipboard window to the target position. Thus the operation is convenient for the user.

In one embodiment, if the instruction of clicking the prompt icon is acquired after the clipboard window is displayed, then the display module 30 can hide the clipboard window.

In the illustrated embodiment, the display module 30 can hide the clipboard window when no webpage content is needed, thus the coverage of the interface is reduced, and the operation is convenient for the user.

In the illustrated embodiment, the prompt icon is hided when the clipboard is empty, thus the coverage of the interface can be reduced, and the operation is convenient for the user.

In one embodiment, the prompt icon and the clipboard window are cross-page global objects. All the webpage opened by the browser share one prompt icon and one clipboard window.

In the illustrated embodiment, the different webpage contents of different webpage are pasted to the clipboard, and the webpage contents in the clipboard are pasted to the target positions of different webpage. The convenience of the copy-paste operation is improved.

In one embodiment, the paste module 40 is also configured to delete the webpage content corresponding to the copy instruction from the clipboard after the webpage content corresponding to the copy instruction is pasted to the target position. In one embodiment, the paste module 40 is also configured to delete the webpage content corresponding to the copy instruction from the clipboard if the clipboard window is in a displaying status.

In the illustrated embodiment, the deletion of the pasted webpage content from the clipboard and the clipboard window can reduce the entry displayed in the clipboard, simply the display of the clipboard window, and is convenient for the user to select the webpage content from the clipboard window and paste the webpage content.

Furthermore, the present invention provides one or more computer storage medium including computer-executable instruction. The computer-executable instruction is configured to execute a method for copying and pasting webpage content. It is apparent to those skilled in the art that part of or all the flow processes of the method according to the embodiment can be implemented using relevant hardware instructed by computer program; the computer program code can be stored in the computer-readable storage medium. The flow process of the method according to the embodiment can be implemented when the program is executed. The storage medium can be disk, compact disc, Read-Only Memory (ROM) or Random Access Memory (RAM) and so on.

Although the present invention has been described with reference to the embodiments thereof and the best modes for carrying out the present invention, it is apparent to those skilled in the art that a variety of modifications and changes may be made without departing from the scope of the present invention, which is intended to be defined by the appended claims.

What is claimed is:

1. A method for copying and pasting webpage content, comprising:
acquiring a copy instruction of copying webpage content;
appending the webpage content to a clipboard, wherein the clipboard is a designated file under a preset directory;
acquiring a paste instruction of pasting the webpage content in the clipboard to a target position; and
pasting the webpage content corresponding to the paste instruction to the target position.

2. The method for copying and pasting webpage content according to claim 1, wherein the step of appending the webpage content to a clipboard comprises:
if the webpage content contains a link, appending a URL information of a target object pointed by the contained link to the clipboard.

3. The method for copying and pasting webpage content according to claim 2, wherein the step of pasting the webpage content corresponding to the paste instruction to the target position comprises:
pasting the URL information of the target object pointed by the contained link in the webpage content corresponding to the paste instruction to the target position.

4. The method for copying and pasting webpage content according to claim 1, further comprising:
displaying a prompt icon for prompting that there is a content in the clipboard when the clipboard is not empty;
displaying a clipboard window when an instruction of clicking the prompt icon is acquired, wherein the clipboard window displays the webpage content contained in the clipboard; and
hiding the prompt icon when the clipboard is empty.

5. The method for copying and pasting webpage content according to claim 4, wherein the prompt icon and the clipboard window are cross-page global objects.

6. A system for copying and pasting webpage content, comprising:
an instruction acquiring module configured to acquire a copy instruction of copying webpage content;
a copy module configured to append the webpage content to a clipboard, wherein clipboard is a designated file under a preset directory;
the instruction acquiring module is also configured to acquire a paste instruction of pasting the webpage content in the clipboard to a target position; and
a paste module configured to paste the webpage content corresponding to the paste instruction to the target position.

7. The system for copying and pasting webpage content according to claim 6, wherein the copy module is configured to: if the webpage content contains a link, append an URL information of a target object pointed by the contained link to the clipboard.

8. The system for copying and pasting webpage content according to claim 7, wherein the paste module is configured to paste the URL information of the target object pointed by the contained link in the webpage content corresponding to the paste instruction to the target position.

9. The system for copying and pasting webpage content according to claim 6, wherein the system further comprises a display module, wherein
when the clipboard is not empty, the display module is configured to display a prompt icon for prompting that there is a content in the clipboard;
when an instruction of clicking the prompt icon is acquired, the display module is configured to display a clipboard window, the clipboard window displays the webpage content contained in the clipboard; and
when the clipboard is empty, the display module is configured to hide the prompt icon.

10. The system for copying and pasting webpage content according to claim 9, wherein the prompt icon and the clipboard window are cross-page global objects.

11. A non-transitory computer storage medium comprising computer-executable instructions, wherein the computer-executable instructions are configured such that when executed by one or more processors, the computer-executable instructions cause a system to perform to execute a method for copying and pasting webpage content, the method comprising:
acquiring a copy instruction of copying webpage content;
appending the webpage content to a clipboard, wherein the clipboard is a designated file under a preset directory;
acquiring a paste instruction of pasting the webpage content in the clipboard to a target position; and
pasting the webpage content corresponding to the paste instruction to the target position.

12. The non-transitory computer storage medium according to claim 11, wherein the step of appending the webpage content to a clipboard comprises:
if the webpage content contains a link, appending a URL information of a target object pointed by the contained link to the clipboard.

13. The non-transitory computer storage medium according to claim 12, wherein the step of pasting the webpage content corresponding to the paste instruction to the target position comprises:
pasting the URL information of the target object pointed by the contained link in the webpage content corresponding to the paste instruction to the target position.

14. The non-transitory computer storage medium according to claim 11, wherein the method further comprises:
displaying an prompt icon for prompting that there is a content in the clipboard when the clipboard is not empty;
displaying a clipboard window when an instruction of clicking the prompt icon is acquired, wherein the clipboard window displays the webpage content contained in the clipboard; and
hiding the prompt icon when the clipboard is empty.

15. The non-transitory computer storage medium according to claim 14, wherein the prompt icon and the clipboard window are cross-page global objects.
